(19) United States
(12) Patent Application Publication
(10) Pub. No.: US 2007/0175906 A1
(43) Pub. Date: Aug. 2, 2007

(54) Insulated Disposable Recyclabe Bottle

(76) Inventor: Frank Caladrino, Ocean Port, NJ (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/670,447

(22) Filed: Feb. 2, 2007

Related U.S. Application Data
(60) Provisional application No. 60/764,548, filed on Feb. 2, 2006.

(51) Int. Cl. A47J 41/00; B65D 81/38

(52) U.S. Cl. 220/592.17; 220/592.16

(57) ABSTRACT

An insulated beverage receptacle that comprises a container for holding a beverage to be insulated, the container having a recessed outer layer; and an insulation layer within the recess, the insulation layer comprising a plurality of plastic encased air bubbles.

### CROSS REFERENCE TO RELATED APPLICATIONS

This application claims benefit to provisional application 60/764,548, filed on Feb. 2, 2006, entitled “Insulated Disposable Recyclable Bottle”, which is incorporated by reference herein in its entirety.

### FIELD OF THE INVENTION

The present invention is directed toward the field of insulated caps, bottles and containers. In particular, the present invention is directed to an insulated plastic bottle with a recessed cylinder that is wrapped with a bubble film.

### BACKGROUND OF THE INVENTION

There are approximately 30 billion plastic bottles sold in North America alone each year. Typically, it is difficult to insulate these bottles. To be kept cold, bottles constructed from plastic and glass often are stored in refrigerators or coolers. A number of separate sleeved designs have been developed to insulate hot and cold beverages. These include insulated sleeves, ice packs and foam rubber jackets.

A number of patents have been issued in the field of insulating plastic and/or containers. U.S. Pat. No. 4,782,670 discloses an insulated beverage container having both hot and cold retention capabilities designed for the purpose of maintaining, increasing, or decreasing the temperature of the contents in the container. The plastic structure of the container is an insulating sleeve between dual walls of the container and encapsulated between the dual walls. A thermoplastic gel capable of retaining heat as well as cold, produces a multi-action container which can be heated in a microwave oven, a conventional oven, or can be frozen in a freezer. The hot-cold embodiment is available in the form of pitchers, as well as cups and mugs and is also dishwasher safe. A second Styrofoam embodiment of the invention is structured as a can or bottle holder and has inner walls containing a cold insulation medium which can be refrigerated or frozen and is designed to maintain or decrease the temperature of the contents in the held can or bottle for prolonged periods of time.

U.S. patent application No. 5,329,778 discloses a thermal insulated bottle that includes an outer container having an open end and an inner cup which is at least partially received and spaced apart from the outer container. The inner cup and outer container engage each other, preferably by a shoulder at the open end of the outer container, which encloses the space between the inner cup and the outer container to form a chamber. Within the chamber, a sleeve of freezable fluid is positioned around the inner cup. A thermal insulating material occupies the rest of the chamber between the sleeve and the outer container.

U.S. Pat. No. 6,209,344 discloses a pre-form and a blow molded container formed therefrom that has plural cavities or compartments for providing enhanced properties, including vacuum containers for hot and cold products or barrier materials, including gases or layered material, improved creep resistance, use of lower cost and/or recycled materials, and increased wall strength and aerosol properties.

U.S. Pat. No. 5,706,969 discloses an insulated container used, for example, as a cooler box, a thermos flask or an insulated lunch box, a suitable insulating material for such a container, along with a method for its manufacture. The insulated container of the present invention is made with an insulating layer between the inner and outer walls of a double walled container with the inner and outer walls joined together as one, and has an insulating material, made by filling a bag with a low thermal conductivity gas comprising at least one of gases such as Xenon, Krypton and Argon, that is disposed between the inner and outer walls. The method of manufacturing the insulated container involves the steps of inserting a bag into the space of the double walled container, filling the bag inserted into the space with a low thermal conductivity gas, and sealing the bag.

U.S. Pat. No. 5,243,835 discloses a thermal insulated bottle that includes an outer container having an open end and an inner cup which is at least partially received and spaced apart from the outer container. The inner cup and outer container engage each other, preferably by a shoulder at the open end of the outer container which encloses the space between the inner cup and the outer container to form a chamber. Within the chamber, a sleeve of freezable fluid is positioned around the inner cup. A thermal insulating material occupies the rest of the chamber between the sleeve and the outer container.

U.S. Pat. No. 5,001,907 discloses a beverage container including an inner tubular wall defining a reservoir; a transparent outer tubular wall surrounding the inner wall and spaced therefrom to form an annular chamber having upper and lower annular openings; a top wall joining upper ends of the inner and outer walls and closing the upper opening; a base closing the lower opening; and a refrigerant gel retained within the chamber.

U.S. Pat. No. 6,139,188 discloses an insulated transit bag which is made from bubble-wrap material and bonded to aluminum foil. The material is doubled-over, folded, and heat welded to form sealed seams. The bag is used for transporting heat-sensitive medicines etc.

U.S. Pat. No. 6,000,575 discloses a hard plastic or nylon beverage insulator holder mated with a suction cup and inserted into the accepting ring of the beverage insulator holder, specifically designed to firmly secure the unit to a smooth surface. The beverage insulator holder is dimensioned to receive a standard sized beverage insulator and a beverage container, such as a can or a bottle. The beverage insulator holder is also equipped with cup handle notch outs on opposing sides to receive coffee cup handles and finger slots for ease of receiving and removing the beverage insulator. The false bottom ensures a flat and stable surface for the beverage insulator. The four stabilizing feet ensure the stability of the unit. The beverage insulator holder is designed to accept beverage insulators, beverage containers with handles, and beverage containers.

U.S. Design Pat. No. D505,838 discloses an ornamental design for a sleeve for beverage container.

U.S. Pat. No. 6,571,976 discloses a sleeve for holding a container that includes an enclosed wall and a flexible concave base defining an orifice. The flexible concave base connects to the cylindrical wall with the orifice within the enclosed wall. The flexible concave base opens away from said enclosed wall. The sleeve insulates the containers, holds the container, attaches the container to a surface, and eases the removal of the container from the sleeve.

U.S. Pat. No. 5,405,671 discloses an improved insulation wrap which consists of a first layer of flexible material. A second layer of flexible material is secured to the first layer, so as to form bubble sheeting having a plurality of cavities there between. A liquid with reflective particles is carried within the cavities. In one instance, cold can be induced into the liquid and in another instance, heat can be induced into the liquid, to maintain a desired temperature therein, depending on application and use of the bubble sheeting.

U.S. Pat. No. 5,243,835 discloses a thermal insulated bottle which includes an outer container having an open end and an inner cup which is at least partially received and spaced apart from the outer container. The inner cup and outer container engage each other, preferably by a shoulder at the open end of the outer container which encloses the space between the inner cup and the outer container to form a chamber. Within the chamber, a sleeve of freezable fluid is positioned around the inner cup. A thermal insulating material occupies the rest of the chamber between the sleeve and the outer container.

U.S. Pat. No. 5,555,746 discloses a portable container for insulating and supporting disposable plastic liter bottles. A first embodiment includes a foamed plastic polystyrene type housing with a molded handle. A pitcher type model with can fixably and snugly used to support the liter bottle therein. An alternative includes a removable refrigerant material such as Blue-Ice and can be inserted within the interior bottom of the housing. A top portion is snapably or threadably detached from the housing. The housing is shaped to closely conform to a standard liter bottle. A second embodiment has double walls with the refrigerant material or insulative foam there-between. A third embodiment has a bottom portion of the housing detachable from the rest and can also contain a cold pack of refrigerant material that can be pre-frozen by itself before using the invention. The fourth and fifth embodiments utilize wet-suit type outer housings with zippers and plastic type handles. The fifth embodiment includes another removable ice-pack that can be pre-frozen before the invention is used.

U.S. Patent Application No. 20030234201 discloses a gift bag which includes a bottom wall and side walls joined together to form a storage chamber there between and having an top opening. The walls are made of paper or a paper-plastic laminate and are lined on the inside with a cellular cushioning material to protect a glass bottle or other fragile gift item from damage. The cellular cushioning material is a laminated material consisting of two thin sheets of flexible plastic, one of the sheets being formed with a plurality of spaced apart pockets of sealed air cells. A string is threaded through holes which are formed in the side walls near the top opening, so that the bag can be closed off by pulling the string. The outer surfaces of the walls are decorated. The gift bag can be folded into a substantially flat configuration for storage and shipping.

U.S. Patent Application No. 20040172921 discloses a method of promoting bottled beverage products by promoting an individual bottle cooler which is made specifically for that bottled beverage product. The bottle cooler preferably comprises a container for holding ice and/or water that is adapted to have the beverage bottle positioned substantially therein, wherein regular ice and/or water from standard ice dispensers and can be stored and sealed within the space between the bottle and container to help keep the beverage inside cool. The space is preferably substantially sealed by a cap which is adapted with an opening and a sealing member that extends over the neck of the bottle, wherein the bottle can be held in substantial compression between the sealing member and one or more supporting surfaces extending substantially underneath the bottle.

U.S. Patent Application No. 20030146227 discloses a method of promoting bottled beverage products by promoting an individual bottle cooler that is made specifically for that bottled beverage product. The bottle cooler preferably comprises a container for containing ice and/or water that is adapted to have the beverage bottle positioned substantially therein, wherein regular ice and/or water from standard ice dispensers can be stored and sealed within the space between the bottle and container to help keep the beverage inside cool. The space is preferably substantially sealed by a cap which is adapted with an opening and a sealing member that extends over the neck of the bottle, wherein the bottle can be held in substantial compression between the sealing member and one or more supporting surfaces extending substantially underneath the bottle.

U.S. Patent Application No. 20030075549 discloses an insulating jacket for a can or bottle which is made of bubble film. The jacket is made from a folded blanket which provides an insulating base integral with a fold fat sleeve. The patent disclosed methods of forming the jacket seam from different blanks. The jacket is disposable or additionally insulated with metallised or printed film.

While there have been a number of systems for insulating bottles, there is a need for a system which can be used to provide insulation for hot and cold drinks.

It is an object of the present invention to provide a bottle insulation system for hot and cold drinks.

It is a further object of the present invention to provide a bottle insulation system.

It is yet a further object of the present invention to provide a bottle insulation system which includes a bubble type insulation system.

### SUMMARY OF THE INVENTION

In accordance with the present invention, the invention is an insulated beverage receptacle that comprises a container for holding a beverage to be insulated. The container has a recessed outer layer and an insulation layer within the recess, the insulation layer comprises a plurality of plastic encased air bubbles.

In yet another embodiment, the invention is an insulated beverage receptacle comprising a bottle for a cold or hot beverage to be insulated; the bottle has a recessed outer layer and an insulation layer within the recessed outer layer, said insulation layer comprises a bubble wrap.

In still a further embodiment, the invention is an insulated beverage receptacle comprising a bottle for a cold or hot beverage to be insulated. The bottle has a recessed outer layer; an insulation layer within the recessed outer layer, said insulation layer comprises a bubble wrap; and an outer sleeve surrounding the insulation layer.

### BRIEF DESCRIPTION OF THE FIGURES

FIG. 1 is a side view of the bottle of the present invention.

FIG. 2 is a section view of the bottle of the present invention.

FIG. 3 is a side view of an insulated cup in accordance with the invention.

FIG. 4 is a sectional view of the insulated cup in accordance with the invention.

FIG. 4a is an overhead view of FIG. 4.

FIG. 5 is a side view of an insulated recyclable plastic container in accordance with the invention.

FIG. 6 is a sectional view of an insulated recyclable plastic container in accordance with the invention.

FIG. 6a is an overhead view of FIG. 6.

### DESCRIPTION OF THE PREFERRED EMBODIMENT

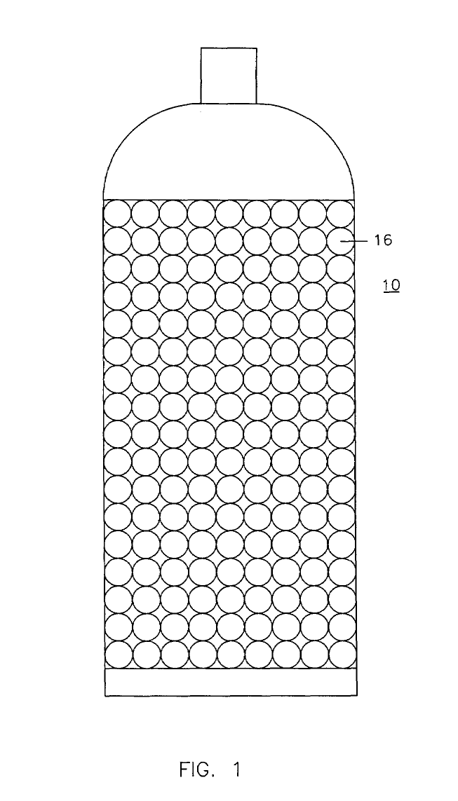

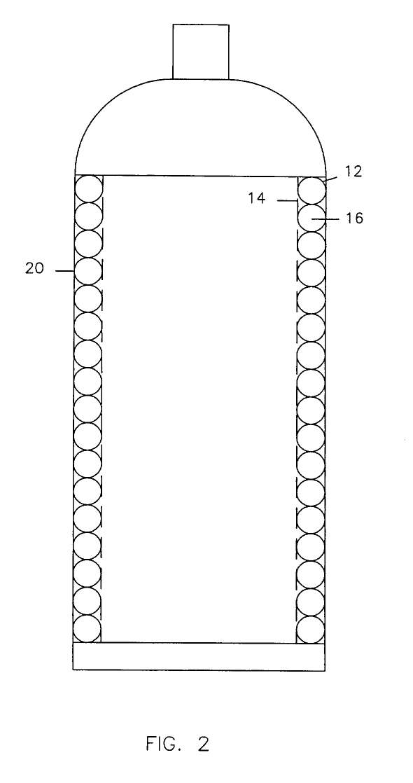

The present invention is described with reference to the enclosed Figures wherein the same numbers are used where applicable. FIGS. 1 and 2 are side views of a first embodiment of the present invention. In the first embodiment, the invention comprises a cylindrical bottle 10. The bottle 10 may be constructed from recyclable plastic. The bottle 10 has a recessed wall 12 about its outer perimeter 20 and inner perimeter 14. The wall 12 is surrounded by a bubble wrap film 16 which is recessed into the wall 12 and lies flush against the interface.

The bubble film 16 comprises a plurality of air cavities, each enclosed by plastic. The bubble wrap 16 functions as insulation for the bottle 10. The invention acts as an insulation for both hot and cold drinks and protects the hands of the user from burns in the case of heated drinks. An outer layer of plastic may form an outer sleeve around the insulating layer.

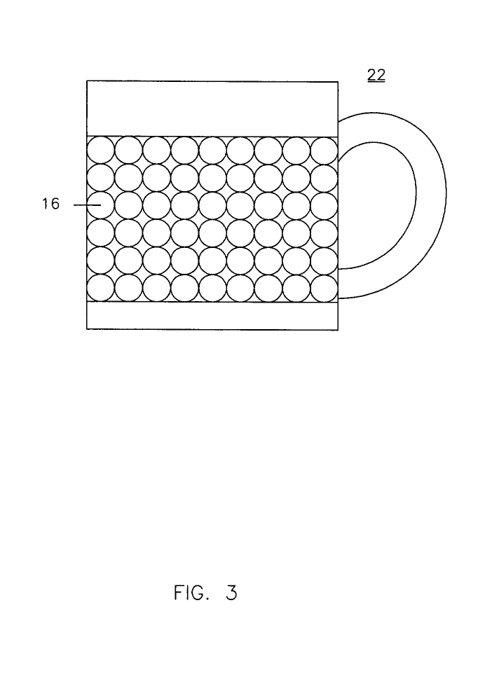

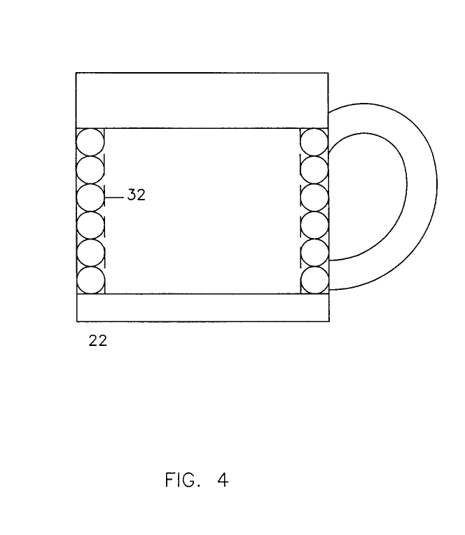

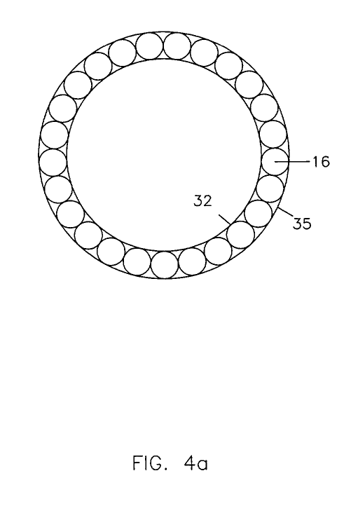

FIGS. 3 and 4 illustrate an embodiment of the invention in the form of a recyclable plastic cup or mug 22. The mug 22 has recessed sidewalls 32 which support the bubble wrap. As with the first embodiment, the embodiment is designed to provide insulation for both hot and cold drinks. As shown in FIG. 4a, the mug has a recessed wall and an outer sleeve 35.

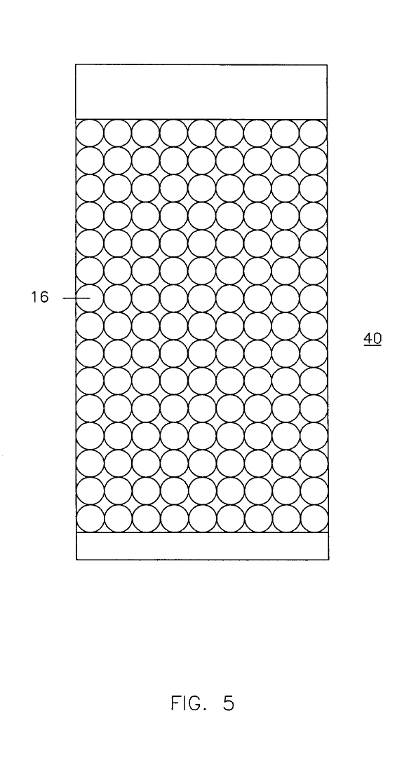

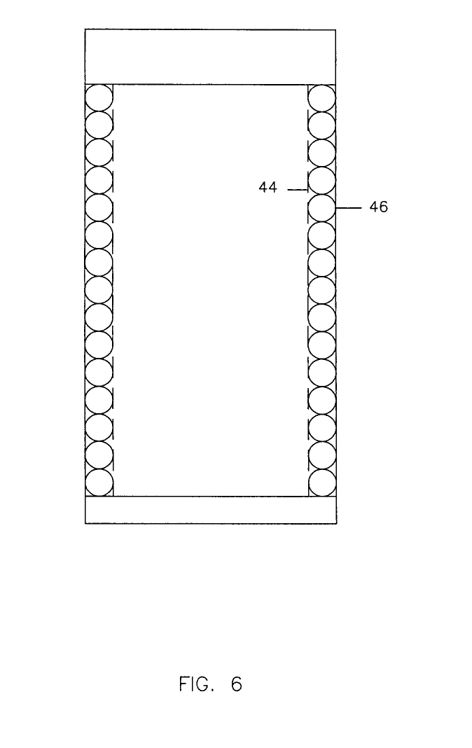

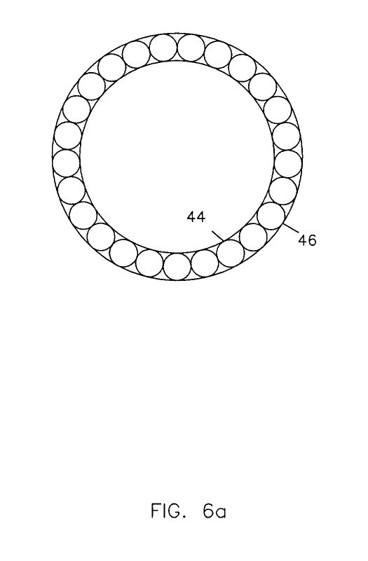

FIGS. 5 and 6 illustrate a further embodiment in the film of an insulated recyclable plastic container 40. The insulated recyclable plastic insulates the temperature of the drink and further minimized condensation. As in the above embodiments, the recyclable plastic container 40 has a recessed outer wall 44 which supports the bubble wrap 16. As shown in FIG. 6a, an outer sleeve 46 surrounds the bubble wrap.

The present invention has a number of advantages. The invention can be produced inexpensively and can be produced in a variety of colors. It is further recyclable and can be reused.

In one embodiment, the invention combines a standard clear plastic disposable bottle having a recess to accommodate an insulation layer of bubble film and a layer of insulation comprising primarily of manufactured bubble film that is inexpensive, made in a variety of colors, translucent and further possesses insulating properties. The present invention is further comprised of inexpensive materials which are disposable and recyclable to allow mass production of the product.

The present invention has been described with reference to the enclosed preferred embodiment. The true nature and scope of the invention is to be determined with reference to the attached claims.

I claim:

1. An insulated beverage receptacle comprising:
a container for holding a beverage to be insulated, the container having a recessed outer layer; and
an insulation layer within the recess, the insulation layer comprising a plurality of plastic encased air bubbles.

2. The insulated bottle receptacle of claim 1, wherein the container is made of recyclable plastic.

3. The insulated bottle receptacle of claim 1, wherein the container is a bottle.

4. The insulated bottle receptacle of claim 1, wherein the container is a cup.

5. The insulated beverage receptacle of claim 1, wherein there are a plurality of plastic encased bubbles comprised from bubble wrap.

6. An insulated beverage receptacle comprising:
a bottle for cold or hot beverage to be insulated;
the bottle having a recessed outer layer; and
an insulation layer within the recessed outer layer, said insulation layer comprised from bubble wrap.

7. The insulated beverage receptacle of claim 6, further comprising an outer sheet surrounding the bubble wrap layer.

8. An insulated beverage receptacle comprising:
a bottle for a cold or hot beverage to be insulated;
the bottle having a recessed outer layer;
an insulation layer within the recessed outer layer, said insulation layer comprising a bubble wrap; and
an outer sleeve surrounding the insulation layer.
